(19) United States
(12) Patent Application Publication
(10) Pub. No.: US 2006/0210425 A1
(43) Pub. Date: Sep. 21, 2006

(54) Inorganic coatings for optical and other applications

(76) Inventor: Laura Mirkarimi, Sunol, CA (US)

Correspondence Address: AVAGO TECHNOLOGIES, LTD., P.O. BOX 1920, DENVER, CO, 80201-1920, US

(21) Appl. No.: 11/086,684

(22) Filed: Mar. 21, 2005

(51) Int. Cl. G01N 31/22

(52) U.S. Cl. 422/56

(57) ABSTRACT

In accordance with the invention, a method of making a device having improved surface properties is provided. The subject method involves contacting a surface of a device with a vaporized inorganic compound under conditions suitable for production of an inorganic coating on the surface, where the surface is a dielectric surface of an optical component or a sample-contact surface of a device adapted to be contacted with an analyte-containing sample. Also provided are devices having a vapor deposited inorganic coating, as well as methods of using such devices.

### BACKGROUND OF THE INVENTION

Numerous types of devices are contacted with an aqueous sample that contains analytes. Such devices include, among others: a) sensing devices for detecting an analyte in a sample, and b) micro-fluidic devices in which analytes in a sample are moved from one place to another, reacted, and/or separated on the surface of a solid support.

In use of such devices, the surface with which the sample makes contact, i.e., the sample contact surface, should have suitable biochemical and physical properties. For example, the sample contact surface of certain devices should be non-reactive with analytes in the sample, non-porous and free of major physical imperfections. In another example, the sample contact surface should have a chemistry that allows it to efficiently bind to capture agents to allow detection of particular analytes in a sample.

In general, materials that contain silica, such as glass and quartz, are thought to have good properties and have long been employed in many devices that are contacted with an analyte-containing sample. For example, microarray substrates for use in detecting polynucleotide and polypeptide analytes in a sample are generally made of glass. In the preparation of a microarray, the microarray substrate (typically a planar glass slide) is derivatized using known silanol-based chemistry to produce reactive sites, and capture agents are linked to the reactive sites to produce the microarray. The microarray is then contacted with a sample and analytes bind to the capture agents on the array. The microarray is then washed and read to provide data.

However, many devices have a sample contact surface with properties that are sub-optimal for the intended use of the device. For example, devices that detect an evanescent wave (e.g., surface plasmon resonance (SPR) devices) require that a capture agent is proximal to a layer of pure metal (e.g., gold or silver). The sample is contacted with the capture agent and analyte that is bound by the capture agent is detected by detecting a change in an evanescent wave. In general, pure metals are not efficiently bound to capture agents, and, as such, the sensitivity of evanescent wave-based sensors is limited. In another example, because of the particular physical requirements for the materials used in micro-fluidic devices, such devices are generally made from polydimethylsiloxane (PDMS) and polyimide. PDMS and polyimide are known to react with certain analytes, limiting the utility of such devices for the assessment of samples containing those analytes.

Accordingly and in view of the above, there is an ongoing need for devices having improved sample contact surface properties, as well as methods for making the same.

Further, optical components (e.g., lenses, mirrors, filters, etc.) of optical devices may be coated to provide a hydrophobic surface (e.g., coated in hydrophobic silane molecules) in order to repel charged particulate matter (e.g., dust) from the component surface. However, primarily to reduce the manufacturing costs of such devices, the devices are becoming physically smaller and are being made from organic dielectric materials (e.g., polycarbonates, acrylics, silicones, etc.) rather than traditional inorganic dielectric materials (e.g., glass, TiO₂ or quartz, i.e., SiO₂). The surfaces of optical components made from organic dielectric materials are generally porous, irregularly shaped and have inhomogeneous chemistry. As such, such devices are often difficult to effectively coat with a hydrophobic coating. Accordingly, in addition to the above, there is also a great need for optical components having improved surface properties, as well as methods of making the same.

References of interest include: published U.S. patent application US20040261703, which is incorporated herein by reference in its entirety for all purposes.

### SUMMARY OF THE INVENTION

In accordance with the invention, a method of making a device having improved surface properties is provided. The subject method involves contacting a surface of a device with a vaporized inorganic compound under conditions suitable for production of an inorganic coating on the surface, where the surface is a dielectric surface of an optical component or a sample-contact surface of a device adapted to be contacted with an analyte-containing sample. The inorganic coating provides a suitable surface for attaching capture agents, transporting analytes, depositing a further coating, e.g., a hydrophobic coating, or the like. Also provided in accordance with the invention are devices comprising a surface having a vapor deposited inorganic coating, e.g., a layer of silicon dioxide. In accordance with the invention, methods of using the subject devices, as well as kits for performing those methods are provided.

### BRIEF DESCRIPTION OF THE DRAWINGS

According to common practice, the various features of the drawings may not be drawn to-scale. On the contrary, the dimensions of the various features may be arbitrarily expanded or reduced for clarity. Included in the drawings are the following figures:

FIG. 1A illustrates a first embodiment in accordance with the invention.

FIG. 1B illustrates a second embodiment in accordance with the invention.

FIG. 1C illustrates a third embodiment in accordance with the invention.

FIG. 1D illustrates a fourth embodiment in accordance with the invention.

FIG. 2A schematically illustrates a first embodiment of an exemplary evanescent wave sensor device in accordance with the invention.

FIG. 2B schematically illustrates a second embodiment of an exemplary evanescent wave sensor device in accordance with the invention.

FIG. 3 schematically illustrates a perforated metal surface filter.

FIG. 4A schematically illustrates a photonic crystal resonator sensor (viewed from the top).

FIG. 4B schematically illustrates a photonic crystal resonator sensor in accordance with the invention (viewed from the side).

FIG. 5 schematically illustrates an exemplary configuration of a dielectric photonic crystal resonator sensor.

### DEFINITIONS

Before the present invention is further described, it is to be understood that this invention is not limited to particular embodiments described, as such may of course vary. It is also to be understood that the terminology used herein is for the purpose of describing particular embodiments only, and is not intended to be limiting. Unless defined otherwise, all technical and scientific terms used herein have the same meaning as commonly understood by one skilled in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Throughout this application, various publications, patents and published patent applications are cited. The disclosures of these publications, patents and published patent applications referenced in this application are hereby incorporated by reference in their entirety into the present disclosure. Citation herein by Applicant of a publication, patent, or published patent application is not an admission by Applicant of said publication, patent, or published patent application as prior art.

It must be noted that as used herein and in the appended claims, the singular forms “a”, “and”, and “the” include plural referents unless the context clearly dictates otherwise. Thus, for example, reference to “a layer” includes a plurality of such layers, and reference to “the capture agent” includes reference to one or more capture agent and equivalents thereof known to those skilled in the art, and so forth. It is further noted that the claims may be drafted to exclude any optional element. As such, this statement is intended to serve as antecedent basis for use of such exclusive terminology as “solely”, “only” and the like in connection with the recitation of claim elements, or the use of a “negative” limitation.

A “vapor-deposited” coating or a “vapor deposition-deposited” coating, i.e., a layer on top of a surface, is a coating that has been deposited by chemical vapor deposition.

“Low-temperature” vapor deposition methods are vapor deposition methods in which a composition is contacted with a vapor at a temperature in the range of 20° C. to 200° C.

The term “optical component” refers to a composition that is employed to manipulate at least one wavelength of electromagnetic radiation. In representative embodiments and as will be described in greater detail below, an optical component may be a lens, mirror, filter, polarizer, beam splitter, optical coupler or prism, for example. Optical components that may be employed herein are described in greater detail below.

A “dielectric surface” of an optical component is a surface of an optical component made from a dielectric material. Materials deposited onto or present on a dielectric surface of an optical component may be in direct contact with the dielectric material.

A “sample-contact surface” is a surface region of a device that is adapted to be contacted with an analyte-containing sample. A sample is deposited or transported onto a sample-contact surface. A sample-contact surface may be an area of an analyte detection device or an area of a microfluidics device. In certain embodiments, a sample contact surface contains capture agents.

The term “sample” as used herein relates to a material or mixture of materials, typically, although not necessarily, in fluid form, e.g., gas, aqueous or in solvent, containing one or more molecules of interest. Samples may be derived from a variety of sources such as from foodstuffs, environmental materials, or biological samples.

Molecules in a sample are termed “analytes” herein. In certain embodiments, a sample may contain a purified analyte.

The term “analyte” is used herein to refer to a known or unknown molecule of a sample, which will specifically bind to a capture agent on a surface if the analyte and the capture agent are members of a specific binding pair. Polypeptide and polynucleotide capture agents may be employed herein.

If one composition is “bound” to another composition, the compositions do not have to be in direct contact with each other. In other words, bonding may be direct or indirect, and, as such, if two compositions (e.g., a sample-contact surface and a capture agent) are bound to each other, there may be at least one other composition (e.g., another layer) between to those compositions. Binding between any two compositions described herein may be covalent or non-covalent. The terms “bound” and “linked” are used interchangeably herein.

A “prism” is a transparent component that is bounded in part by two nonparallel plane faces and is used to refract or disperse a beam of light. The term prism encompasses round, cylindrical-plane lenses (e.g., semicircular cylinders) and a plurality of optically matched transparent components that have been brought together.

Other definitions of terms appear throughout the specification.

### DETAILED DESCRIPTION

In accordance with the invention, a method of making a device having improved surface properties is provided. The subject method involves contacting a surface of a device with a vaporized inorganic compound under conditions suitable for production of an inorganic coating on the surface, where the surface is a dielectric surface of an optical component or a sample-contact surface of a device adapted to be contacted with an analyte-containing sample. The inorganic coating provides a suitable surface for attaching capture agents, transporting analytes, depositing a further coating, e.g., a hydrophobic coating, or the like. Also provided in accordance with the invention are devices comprising a surface having a vapor deposited inorganic coating, e.g., a layer of silicon dioxide. In accordance with the invention, methods of using the subject devices, as well as kits for performing those methods are provided.

The subject methods will be described first, followed by a description of the devices that may be made using those methods. Following this, kits for performing these methods are described. Finally, a discussion of representative methods of using a subject device are presented.

Methods of Making a Subject Device

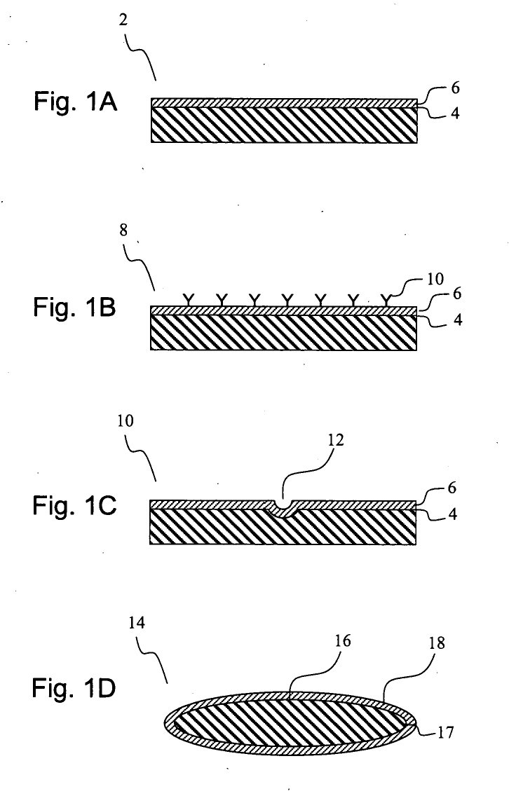

A method of coating a surface in an inorganic compound is provided. In certain embodiments, the surface may be a dielectric surface of an optical component or a sample-contact surface of a device adapted to be contacted with an analyte-containing sample. In accordance with the invention, therefore, a surface having a vapor deposited inorganic coating is provided. The surface may be chosen from a dielectric surface of an optical component and a sample-contact surface of a device adapted to be contacted with an analyte-containing sample. Referring to FIG. 1A, the device 2 contains a surface 4 and an inorganic coating 6 that has been deposited by chemical vapor deposition. In other words, the surface is coated in a vapor deposited inorganic material. As will be described in greater detail below and in certain embodiments, the vapor deposited inorganic coating provides a surface having desirable chemical and/or physical properties, and improves the performance of the device. For example, the inorganic coating may be further modified to provide capture agents or a hydrophobic coating on the surface of the device.

In one embodiment, the surface that is coated is a surface of an optical component. The term “optical component”, as used herein, is any component that is employed to manipulate, e.g., deflect, reflect, diffract, filter, polarize, transmit or split at least one wavelength of electromagnetic radiation. In one embodiment, an optical component is employed to manipulate at least one wavelength of light, e.g., a wavelength of visible, infra-red or uv light. Optical components are generally at least partially transparent or reflective to at least one wavelength of light (e.g., light having a wavelength in the range of about 500 nm to 2000 nm, e.g., 600 to 1200 nm) and employed within an optical device for that purpose. An optical component may be a lens, mirror, filter, polarizer, beam splitter, optical coupler or prism, for example. An optical component employed herein may be of any size (e.g., in the range of about 1 μm to about 1 meter in size). In certain embodiments, however, an optical component having a size of about 5 μm to about 5 mm or about 10 μm to about 1 mm in size may be used. A subject optical component may be, for example, refractive, diffractive, anamorphic, aspherical, spherical, convex or concave. The optical components employed herein are generally made of a dielectric material, e.g., a dielectric polymer, and the inorganic layer is deposited directly onto the dielectric material. As illustrated in FIG. 1D, an optical device in accordance with the invention 14 contains an optical component 16 having a dielectric surface 17 and a vapor deposited inorganic coating 18 on dielectric surface 17.

As will be described in greater detail below, a subject optical component may be employed in a variety of devices. For example, a subject optical component may be employed in an optical device to detect an image, e.g., in a camera, scanner, microscope or telescope, in another optical device designed to detect light movement, e.g., an optical computer mouse, or in an optical device that is designed to transmit light signals, e.g., those devices employed in fiber optics. One exemplary device in which a subject optical component may be employed is an optical navigation system, such as optical mouse. In this embodiment in accordance with the invention, all of the optical components of the system, e.g., the lens, optical source, optical detector and the like may be coated with a vapor deposited inorganic layer (of SiO₂, for example). As discussed in greater detail below, the inorganic coating may be further modified, e.g., to provide a dust-repellant hydrophobic surface.

In a further embodiment in accordance with the invention, the subject methods may be employed to coat a sample-contact surface of a device adapted to be contacted with an analyte containing sample. The term “device adapted to be contacted with an analyte-containing sample” encompasses a variety of analyte detection and microfluidic devices having a surface to which an analyte-containing sample is directly contacted (e.g., by depositing, pipetting or otherwise applying a sample to the sample-contact surface of the device). In certain embodiments, the term “device adapted to be contacted with an analyte-containing sample” excludes electrical devices such as semiconductor devices and micro-electromechanical devices that are not directly contacted with an analyte-containing sample.

In one embodiment in accordance with the invention, a device adapted to be contacted with an analyte-containing sample is an “analyte detection device”. An “analyte detection device” is a device that is designed to detect one or more analytes in a sample. In general, a sample is contacted with a sample-contact surface of an analyte detection device and particular analytes in the sample are detected. Analyte detection devices generally have an sample-contact surface that contains capture agents which specifically bind to analytes, and are distinguishable from devices that are not adapted to be contacted with an analyte-containing sample on that basis. In representative embodiments in accordance with the invention and with reference to FIG. 1B, an analyte detection device 8 contains a capture agent 10 linked to the vapor deposited inorganic coating 6 that is present on the sample-contact surface 4.

In another embodiment in accordance with the invention, a device adapted to be contacted with an analyte-containing sample is a microfluidic device. As its name suggests, a microfluidic device is a device that is typically designed to convey an analyte-containing sample from a first position of the device to a second position of the device. Microfluidic devices typically contain channels, wells or reaction regions through which sample travels, and are distinguishable from devices that are not adapted to be contacted with an analyte-containing sample on that basis. Microfluidic devices typically convey samples having a volume ranging from about 1 nl to about 100 nl (e.g., in the range of about 5 nl to about 20 nl). Microfluidic devices may also include valves, mixers and pumps for conveying and mixing different samples, and separation elements for separating the analytes in a sample. Microfluidic devices are generally well known in the art (see, e.g., Hong et al, Nat Biotech. 2003 21:1179-83; Beebe et al, Annual Rev. Biomed. Eng. 2002; 4:261-86; Chovan et al, Trends Biotechnol. 2002 20:116-122 and Wang et al, Electrophoresis 2002 23:713-8) and are readily adapted for use herein. In representative embodiments and with reference to FIG. 1C, microfluidic device 10 contains channel 12, and vapor deposited inorganic coating 6 that is present on surface 4.

The subject devices are typically made by contacting a surface with a vaporized inorganic compound under conditions suitable for production of an inorganic coating on the surface. The inorganic coating may be deposited onto the surface by a process called chemical vapor deposition (CVD). Chemical vapor deposition is a generic name for a group of related processes that involve coating a surface by depositing a solid material from a vapor phase. Chemical vapor deposition methods are generally well known in the art and have been used to apply coatings to devices in the electronic and semiconductor arts (see e.g., Handbook of Chemical Vapor Deposition—Principles, Technology and Applications (2nd Edition) By: Pierson, H. O. 1999 William Andrew Publishing/Noyes).

A wide variety of vapor deposition methods, e.g., rapid thermal chemical vapor deposition (RTCVD), low-pressure chemical vapor deposition (LPCVD), ultra-high vacuum chemical vapor deposition (UHVCVD), atmospheric pressure chemical vapor deposition (APCVD), molecular beam epitaxy (MBE), plasma assisted chemical vapor deposition (PACVD), laser chemical vapor deposition (LCVD), photochemical vapor deposition (PCVD) chemical vapor infiltration (CVI) and plasma-enhanced chemical vapor deposition (PECVD) may be employed in the methods described herein. However, in certain embodiments, vapor deposition methods are employed in which an inorganic coating is deposited at low temperatures (i.e., in the range of about 20° C. to about 250° C., e.g., in the range of about 25° C. to about 100° C. or about 30° C. to about 60° C.) may be employed. In particular embodiments, a process termed herein “molecular vapor deposition” (MVD), as described in published U.S. patent application US20040261703 (incorporated herein in its entirety for all purposes) is used. PACVD or PECVD may also be employed in particular embodiments in accordance with the invention.

Chemical vapor deposition, e.g., MVD, PACVD or PECVD, methods are employed to deposit an inorganic coating of a pre-determined thickness of between about 5 Å to about 1,000 Å, or more than 1,000 Å, onto a surface. In certain embodiments, the inorganic layer is deposited onto part of the surface, e.g., the areas to which sample makes contact (i.e., the sample-contact surface areas), however, in other embodiments, the entire surface may be coated with an inorganic layer. The coating may be covalently linked or non-covalently linked to the surface.

The subject deposition methods, e.g., MVD, PACVD or PECVD methods, may employ conditions suitable for production of an inorganic coating on a surface, which conditions generally include a suitable temperature, e.g., about 20° C. to about 200° C.; a suitable pressure, e.g., about 100 mTorr to about 10 Torr; suitable reactants (e.g., reactive metal-containing precursors that are vapor at the temperature and pressure used); and a suitable reaction time (e.g., from about 5 minutes to about 10 hours or more). Suitable conditions also include co-reactants, e.g., water (H₂O), ammonia (NH₃), nitrogen (N₂), oxygen (O₂), etc., that are reactive with the precursors, and may optionally include surface pre-treatment steps (e.g., pre-washing the surface in e.g., acid, and/or exposing the surface to oxygen plasma to provide reactive surface groups). Chemical vapor deposition may occur in a reaction chamber, i.e., a closed chamber into which a surface may be placed and into which reactant vapors may be transferred and vented out using pumps and/or valves or the like. The temperature and/or pressure within a suitable reaction chamber may be regulatable. The reactant concentrations, temperature and pressure may vary depending on the desired thickness of coating.

Such methods may be employed to produce an inorganic coating of any desired thickness. For example, the instant methods may be employed to produce a coating of from about 5 Å to about 10 Å, from about 10 Å to about 20 Å, from about 20 Å to about 50 Å, from about 50 Å to about 200 Å, from about 200 Å to about 500 Å, from about 500 Å to about 1000 Å, from about 1000 Å to about 2000 Å or greater. The thickness of the coating is generally consistent over the coated surface (i.e., 95% of the coating is at a thickness that is less than two standard deviations from the average thickness).

In one embodiment in accordance with the invention set forth solely to exemplify but not to limit the invention, a molecular vapor deposition apparatus (e.g., a MVD 100 apparatus sold by Applied MicroStructures, Inc., San Jose, Calif.) or a PECVD or PACVD apparatus (as sold by, e.g., Denton Vacuum, Inc, (Moorestown, N.J.), Oxford Instruments (Fremont, Calif.) or Hauzer Techno Coating (Venlo, The Netherlands)) is employed to coat a surface of a subject device. The apparatus contains a reaction chamber for vapor deposition.

Washed surfaces (e.g., acid-washed surfaces) to be coated may be pretreated in the reaction chamber. To obtain covalent bonding of a halo-containing (e.g., chloro-, flouro- or bromo-containing) precursors to a surface (and thereby produce an inorganic layer that is covalently linked to the surface), the surface may be treated to create hydroxyl groups on the surface if such groups are not already present. This may be done in the reaction chamber by treating the surface with oxygen plasma in the presence of moisture. The pressure in the reaction chamber during exposure of a surface to the oxygen plasma may range from about 0.2 Torr to about 2 Torr, e.g., from about 0.5 Torr to about 1 Torr. For a reaction chamber having a volume of about 2 liters, the plasma source gas oxygen flow rate may range from about 50 sccm to about 300 sccm, e.g., about 100 sccm to about 200 sccm. The surface pretreatment time may vary greatly, but may be about 1 minute to about 10 minutes, e.g., 1 minute to about 5 minutes. The impact of the plasma surface treatments on the surface will greatly depend on the power density of the plasma. High density plasmas can alter the microstructure by sputtering the surface with the energetic ions. Low density plasmas are preferred for gentle cleaning and removal of organic materials on the surface while maintaining the surface topography of the sample. Accordingly, the power setting employed in these methods may vary depending on the particular surface to be coated. In certain embodiments, a power setting of about 20 Watts to about 300 Watts may be employed. Alternatively, power settings greater than 300 Watts may be used when a rougher surface is required for a particular application.

In certain embodiments, vapor deposition is carried out under controlled pressure. By controlled pressure is meant that vapor deposition may be carried out in a reaction chamber at a pressure ranging from about 100 mTorr to about 10 Torr, e.g., about 0.5 Torr to about 5 Torr or about 0.1 Torr to about 3 Torr. The temperature employed depends on the particular coating precursors and on the surface material. However, in many embodiments, the temperature employed is generally in the range of about 20° C. to about 200° C., e.g., about 25° C. to about 100° C. or about 30° C. to about 60° C. Accordingly, the interior of the reaction chamber (and the surface) is typically maintained at a particular temperature. The time period used to produce an inorganic coating over a surface may range from about 1 minute to about 10 or about 20 hours e.g., about 2 minutes to about 5 hr, about 3 minutes to about 1 hr or about 5 minutes to about 30 minutes, depending on precursor chemistry and surface material.

In certain embodiments, a precursor is vaporized and used in combination with a suitable co-reactant. Again, depending on the precursor employed, a variety of co-reactants may be employed. For example, in certain embodiments, water, nitrogen, oxygen or ammonia may be used.

The instant methods may be employed to deposit a variety of coatings that can be tailored to provide particular functional characteristics to a coated surface.

Such coatings are generally metal-containing coatings, and include, for example, metal oxide coatings (e.g., oxides or dioxides of silicon, titanium, zirconium, tungsten, copper, nickel, chromium, aluminum, germanium, etc., e.g., silicon or titanium dioxide), metal nitride coatings (e.g., nitrides of silicon, titanium, tungsten, copper, aluminum, zirconium, nickel, chromium, germanium, etc., e.g., titanium nitride) and others that would be readily apparent to one of skill in the art.

Depending on the surface to be coated and the desired coating, any one or more of a wide variety of precursors may be employed. In representative embodiments, the precursors are inorganic precursors. Depending on the desired coating, a precursor that may be employed in the subject methods may be, for example, a metal halide, e.g. SiCl₄, TiCl₄, TaCl₅, WCl₆, HSiCl₃, HTiCl₃, HTaCl₄, HWCl₅ etc.; a metal hydride, e.g. SiH₄, GeH₄, AlH₃, etc.; a metal alkoxide, e.g. Ti(OiPr)₄, etc.; a metal dialylamide, e.g. Ti(NMe₂)₄, etc.; a metal diketonate, e.g. Cu(acac)₂, etc.; or a metal carbonyl, e.g. Ni(CO)₄, etc, or the like. Precursors that vaporize at relatively low temperature (e.g., about 20° C. to about 200° C.) are readily employed in the subject methods. Since the vapor temperatures of a multitude of different potential precursors are known, selection of appropriate precursors would be well within the skill of one of skill in the art.

In certain embodiments in accordance with the invention, co-reactants are used. The co-reactant that should be employed with a particular precursor to produce a particular coating would also be apparent to one of skill in the art. For example, to make a metal nitride coating, e.g., a titanium nitride coating, ammonia or nitrogen may be employed as a co-reactant with a metal-containing precursor such as TiCl₄. In another example, to make a metal oxide-containing coating, e.g., a silicon dioxide (SiO₂) coating, molecular water (H₂O) may be employed as a co-reactant with a metal-containing precursor such as SiCl₄.

In one embodiment, silicon halide, e.g., a tetrahalosiline such as tetrachlorosilane (SiCl₄), tetrafluorosilane (SiF₄) or tetrabromosilane (SiBr₄), or a trihalosilane such as trichlorosilane, (HSiCl₃), trifluorosilane (HSiF₃) or tribromosilane (HSiBr₃) precursors may be employed with water in low temperature embodiments of the instant methods to produce a SiO₂ coating on a surface. Other silicon halide compounds that could be used in the instant methods to produce a SiO₂ coating include R-silane, H-silane, R—H silane, R-siloxane, H-siloxane, R—H siloxane, where R may be any organic constituent (e.g., methyl, dimethyl, ethyl etc) and H can be any number of halogens (e.g., F, Cl, Br and I, including or in combination with H). Further examples of silicon-containing precursors may be found in published U.S. patent application 20030180732, which is incorporated by reference in its entirety for that purpose).

In certain embodiments in accordance with the invention, the vapor deposited coating may be further modified to produce desired surface properties, e.g., by derivatizing the coating to make the surface hydrophobic or hydrophilic, or to add capture agent-reactive sites. This may be done using known silanol-based chemistry that has been applied to glass surfaces in other devices. For example, the vapor deposited coating may be silanated by known chemistry to provide the derivatized surface. Accordingly, in one embodiment in accordance with the invention, a subject device containing a surface having a derivatized vapor deposited inorganic coating (e.g., a SiO₂ coating containing hydrophobic or capture agent-reactive moieties such as inorganic silane groups attached thereto).

If the subject device is an analyte detection device, the inorganic coating may be linked to a capture agent (such as a biopolymer, e.g., a polypeptide such as an antibody or peptide, or a polynucleotide) to facilitate detection of an analyte in a sample. Accordingly, after vapor deposition of a suitable inorganic coating, the coating may be further modified to provide capture agent-reactive groups. For example, coatings that contain hydroxyl groups can be silanized to produce hydrophobic, hydrophilic or biopolymer-reactive groups (e.g., amino- or carboxy-reactive groups) using well known technology. In certain embodiments, the coating may be treated with oxygen plasma (see, e.g., the methods described above) to provide hydroxyl groups if they are not already present. However, in other embodiments, e.g., those that produce a SiO₂ coating, surface-reactive hydroxyl groups are present in the coating immediately after the coating is deposited. Subject surfaces may by silanized by dipping the surface into the appropriate reagents, or using the vapor deposition methods of US20040261703, for example. Representative protocols for functionalization of surfaces, e.g., to bind and display a capture agent or to provide a hydrophobic surface, include but are not limited to the protocols described in published U.S. patent applications 20030044798, 20030180732, 20040018498, 20040063098, 20040076963 and 20040265476.

In one embodiment in accordance with the invention, a SiO₂ coating is vapor deposited onto a surface by maintaining the surface in a closed reaction chamber with water vapor, a vaporized silicon-containing precursor (e.g., a silicon halide) at a temperature in the range of 20° C. to 250° C. and pressure in the range of 100 mTorr to about 10 Torr for a desired length of time (e.g., 1 to 30 minutes).

The instant vapor deposition methods may be employed to deposit an inorganic layer upon a variety of surfaces, e.g., a dielectric surface of an optical component or a sample contact surface of a device adapted to be contacted with an analyte-containing sample. The surface coated using the above-described vapor-deposition methods may be of any material.

In one embodiment in accordance with the invention, an optical component that is made from a dielectric material having an inorganic surface coating, e.g., SiO₂ or TiO₂, is provided. The optical component may be made from a dielectric polymer (e.g., a polycarbonate, polyacryl or a silicone polymer or a dielectric plastic such as cyclic olefin (e.g., TOPAS™ or ZEONOR™), polyolefin, polydimethylsiloxane (PDMS), polymethyl methacrylate (PMMA; e.g., LUCITE™ or PLEXIGLASS™), glass (e.g, Na₂O, Ca₂O, SiO₂ or borosilicate glass) or quartz, for example. The inorganic coating provides a suitable surface for the deposition of a hydrophobic molecules (e.g. organic silanes) to produce an optical component (e.g., a lens or the like) having a hydrophobic surface.

In another embodiment in accordance with the invention, a microfluidic device that is made by depositing an inorganic material, e.g., SiO₂ or TiO₂, onto a sample-contact surface is provided. The sample contact surface of these devices may be made from any suitable polymeric material, including, but not limited to, PDMS (polydimethylsiloxane), parylene, polyimide, vespel, polymethyl methacrylate (PMMA), polyurethane or polystyrene, for example. The inorganic coating provides a chemically stable, non-reactive, wettable surface that is desirable in microfluidic devices.

In another embodiment in accordance with the invention, an analyte detection device that is made by depositing an inorganic material, e.g., SiO₂ or TiO₂, onto a sample-contact surface is provided. The sample contact surface of these devices may be made from any suitable material, including, but not limited to: a metal, such as gold, copper, silver or aluminum; a polymer such as a plastic, e.g., cyclic olefin (e.g., TOPAS™ or ZEONOR™), polyolefin, polydimethylsiloxane (PDMS); polymethyl methacrylate (PMMA; e.g., LUCITE™ or PLEXIGLASS™), polyimide, polycarbonate, polyacryl, parylene, vespel, polyurethane or polystyrene, etc; any dielectric material such as glass (e.g, Na₂O, Ca₂O, SiO₂ or borosilicate glass), silicone, quartz, or a Si-, Ge-, or Al₂O₃-containing dielectric, or a conductive material such as silcon or carbon, for example. The inorganic coating provides suitable chemistry for the efficient attachment of capture agents to the sample contact surface of the device.

In certain embodiments in accordance with the invention, a device adapted to be contacted with an analyte-containing sample is provided. The subject device contains: a sample contact surface (which, in certain embodiments, may be otherwise known as a sensing surface or a substrate surface), and a vapor deposited inorganic coating on that surface. As discussed above, the device may be, for example, an analyte-detection device or a micro-fluidic device.

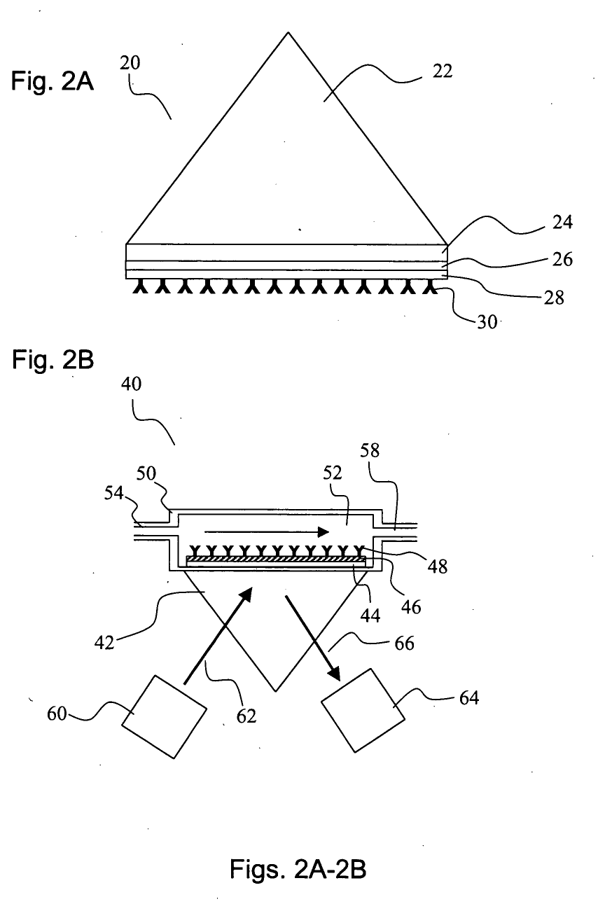

In a representative embodiment in accordance with the invention, a subject device is an evanescent wave detection device. As is known in the art, evanescent wave detection devices include, e.g., surface plasmon resonance devices, grating coupler surface plasmon resonance devices, resonance mirror devices and waveguide sensor interferometry devices. Such evanescent wave-detecting devices may use Mach-Zender or polarimetric methods, as well as direct and indirect evanescent wave detection methods, etc. (see also Myszka J. Mol. Rec. 1999 12:390-408). As is known in the art, such devices generally contain a prism having a planar surface that is coated in a then film of metal, usually a free electron metal such as, e.g., copper, silver, aluminum or gold. An evanescent wave detection device in accordance with the invention further includes a vapor deposited inorganic coating (e.g., a SiO2 or TiO2 coating) on top of the metal film. An exemplary evanescent wave detection device in accordance with the invention is illustrated in FIG. 2A. The evanescent wave sensor 20 contains a prism 22 that is in contact with an optically-matched slide 24 that has a thin metal coating 26, e.g., a gold layer disposed thereon. The vapor deposited inorganic coating 28 discussed above is disposed on the metal coating, forming a surface to which capture agents 30 are readily linked.

Certain evanescent wave sensors such as grating coupled SPR sensors do not require a prism. Both 1D and 2D gratings offer the advantage of a simpler optical system design (see, e.g., Brockman et al., American Laboratory 2001 33:37-40; Thirstrup et al, Sensors and Actuators, B: Chemical, 2004 100(n 3):298-308). Further, a number of devices containing perforated metal structures may be employed as a sensor (See, e.g., U.S. patent application Ser. No. 10/960,711, filed on Oct. 6, 2004).

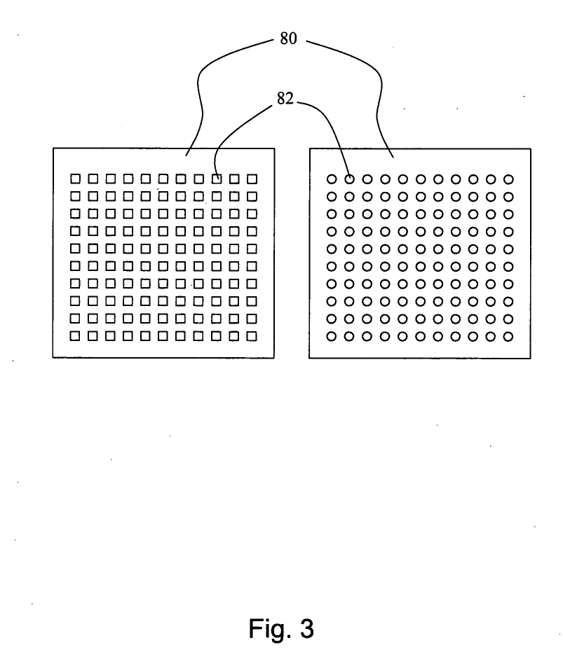

In these sensors, the metal transducer undergoes a change in resonance as material (e.g., a polypeptide or another analyte) adheres to the metal surface. Additional perforated metal structures that may be employed herein are described in Brolo et al (Langmuir 2004 12:4813-4815) and Levine et al (Science 2003 299:682-686). These metal structures do not require prism coupling and may be employed in the subject methods. Accordingly, in one embodiment in accordance with the invention, a photonic crystal sensor comprising an inorganic coating is provided. Schematic representations of exemplary metal perforated sensors that may be employed herein are illustrated in FIG. 3. Representative metal perforated sensors contain a metal element 80 containing perforations 82. The wave sensors in accordance with the invention may possess a thin inorganic coating, e.g. a coating of 5 Å to about 20 Å or about 10 Å to about 50 Å in thickness, of a metal oxide, e.g., SiO₂.

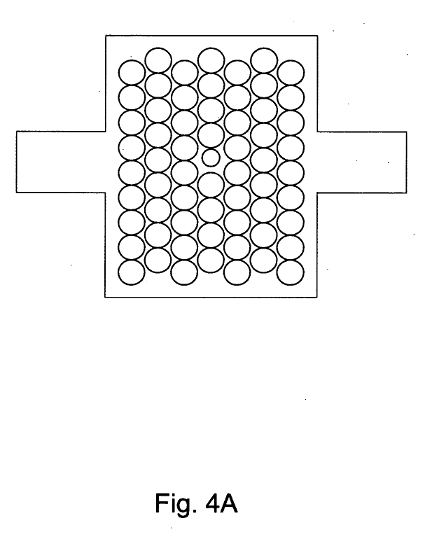

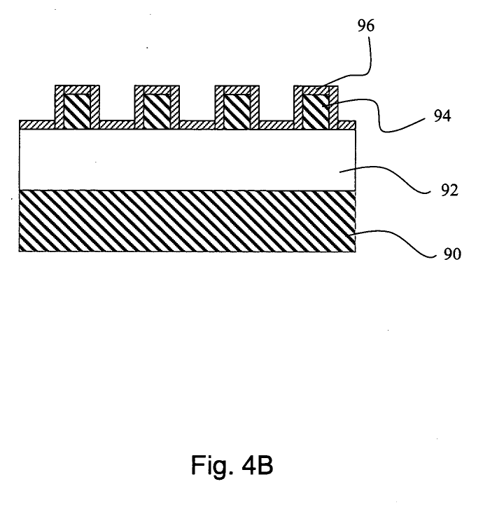

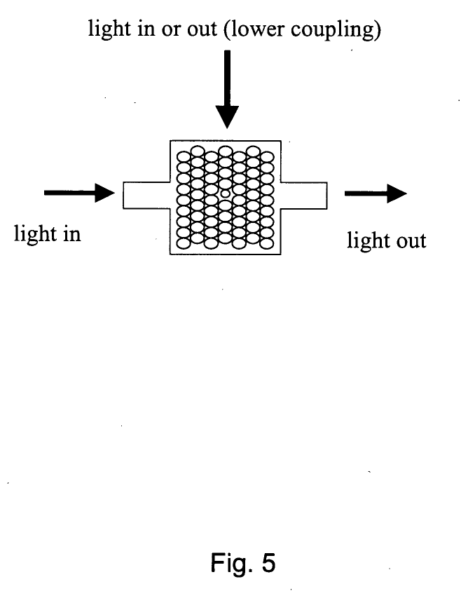

In a further representative embodiment, a photonic crystal resonator (as described U.S. Pat. Nos. 6,775,430, 6,760,514, 6,728,457 and 6,687,447) and in Chow et al (Optics Letters 2004 29:1093-5) may be used as a sensor for detecting analytes in a sample. These dielectric resonators are fabricated by etching 200 nm to 300 nm size holes into a dielectric stack. A defect hole with a radius smaller than the surrounding lattice holes is placed in the center of the sensor to create a resonance. An exemplary dielectric resonator sensor that may be employed herein is schematically shown from the top in FIG. 4A and from the side in FIG. 4B. In one embodiment, a representative dielectic resonator sensor contains silicon (Si) substrate 90, buried thermal oxide layer 92 (e.g., SiO₂), silicon substrate 94 and inorganic coating 96 (of, e.g., SiO₂ or TiO₂). One representative configuration of a dielectric resonator sensor suitable for optical detection of a resonance peak is shown in FIG. 5. The design of dielectric resonator sensor provides for a resonance field within the first tens of nanometers of a pore, i.e., an aperture, which makes them particularly useful as chemical or biological sensors. Because the magnitude of the resonance field decreases rapidly with distance from the semiconductor edge, the inorganic coating employed may be relatively thin, e.g., in the order of about 5 Å to about 20 Å or about 10 Å to about 50 Å in thickness, and may be of a metal oxide, e.g., SiO₂.

In a further representative embodiment in accordance with the invention, the subject device is a nanostructure-containing device. In general, nanostructures that may be used in a subject device are well known in the art (and reviewed in Yang et al. (The Chemistry of Nanostructured Materials (World Scientific Pub Co, 2003)) and Nalwa et al. (Handbook of Nanostructured Materials and Nanotechnology (Academic Press, 2000)) and include linear and branched nanorods or nanowires (Li et al., Ann. N.Y. Acad. Sci. 2003 1006:104-21; Yan et al, J. Am. Chem. Soc. 203 125:4728-4729), nanotubes (e.g., Martin et al., Nat. Rev. Drug Discov. 2003 2:29-37), nanocoils (see, e.g., Bai et al., Materials Letters 52003 7:2629-2633), and porous three-dimensional nano-matrices such as nano-fibers, mesoporous silicates, polymeric foams (see, e.g., Cooper et al, Adv. Mater. 2003 15, 1049-1059, Schuth et al, Adv. Mater. 2002 14, 629-637 and Stein et al, Adv. Mater. 2000 12, 1403-1419) and the like. Also encompassed by the term “nanostructure-containing devices” are metal nanosphere-containing devices employed in surface enhanced Raman spectroscopy (see, e.g., Moore et al. Nat Biotechnol. 2004 22:1133-8), fluorescence spectroscopy or other optical characterization. These metal nano-spheres may benefit from an inorganic coating prior to attaching a fluorescent tag to avoid photo-quenching from the metal (West et. al, J of Phys. Chem. B. 107 (15) p. 3419 (2003). Such devices may be generally employed in a variety of analyte detection methods and may contain an inorganic coating of any thickness.

In one embodiment in accordance with the invention, the device provided is a nanopore sensor (see, e.g., Li et al., Nature Materials 2, 611-615 (2003)). Such devices are proposed for sequencing DNA and can benefit from an inorganic coating of SiO₂ or the like. The fabrication process for nanopore sensors typically involves ion beam sculpting (Nature, v 412, n 6843, 12 Jul. 2001, p 166-9), which, in certain embodiments, often damages a Si₃N₄ membrane that surrounds the nanopore. Accordingly, in certain embodiments, ion beam sculpting can produce a highly defective layer around a nanopore. This defective layer may include compositional inhomogeneities, non-stoichiometric material, structural defects and the like, and makes it difficult to detect analytes passing through the nanopore. By depositing a stoichiometric inorganic coating of, e.g., SiO₂ or TiO₂ or the like, onto the nanopore sensor, the device will perform as predicted for the deposited material. For example, an SiO₂ layer in general is hydrophilic which, in certain embodiments, may be desirable for achieving efficient flow of a liquid sample through the nanopore. In many embodiments, the final diameter of a nanopore is about 5 nm to about 10 nm, and the starting pore used for sculpting the nanopore may be about 30 nm to about 100 vnm in diameter. Nanopore devices therefore generally require a relatively thin inorganic coating of about 10 nm to about 50 nm. In one embodiment, the vapor deposition process replaces the sculpting process entirely.

In another embodiment in accordance with the invention, a nanowire (as described in Zhou et al, Chemical Physics Letters, v 369, n 1-2, 7 Feb. 2003, p 220-4) or nanotube (Chung et al., TRANSDUCERS '03. 12th International Conference on Solid-State Sensors, Actuators and Microsystems. Digest of Technical Papers (Cat. No. 03TH8664), 2003, pt. 1, p 718-21 vol. 1) electrical signal is monitored to assess the amount of an analyte that is attached to a desired surface. Changes in the electrical signal are referenced to binding sites at the nanowire or nanotube surface. The inherent operation of this type of sensor indicates that the interface between the nanowire/nanotube sensor and the analyte should be chemically and electrically stable. Additionally, the thickness of the interfacial layer on the nanowire or nanotube may be minimized to bring the analyte as close to the electrical sensor as possible to improve signal to noise ratios.

A microfluidic device in accordance with the invention is a device that is designed to convey an analyte-containing sample from a first position of the device to a second position of the device, and contains an inorganic coating upon at least part of and in certain embodiments all of the surface over which the analyte containing sample is conveyed. As mentioned above, microfluidic devices typically contain channels, wells or reaction regions through which sample travels. As illustrated in FIG. 1C, a channel, well or reaction region of such a device may contain a vapor deposited inorganic coating according to the above. In one embodiment, a microfluidic device in accordance with the invention contains a capillary electrophoresis system for separating the analytes in a sample. The sample contact regions of a capillary, channel or reaction region of a subject microfluidic device may, in certain embodiments, be coated in a vapor deposited inorganic coating.

In one particular embodiment in accordance with the invention, the analyte-contact surface is made of glass (e.g, Na₂O, Ca₂O, SiO₂ or borosilicate glass) or another material and contains a planar surface that is employed in the production of polypeptide or polynucleotide microarrays. In use, an analyte-contact surface is coated in an inorganic layer, as described above, and polypeptides or polynucleotides are deposited or synthesized onto the inorganic layer to produce an array. Methods for the synthesis of arrays are generally well known in the art (see, e.g., U.S. Pat. Nos. 6,242,266, 6,232,072, 6,180,351, 6,171,797, 6,323,043 and 6319674), and are readily employed herein. Planar glass typically has imperfections such as compositional inhomogeneity and roughness due to its manufacturing process. The vapor deposited inorganic layer will homogenize the surface of the glass, and provide specific chemical moieties (e.g., hydroxyl groups) suitable for the attachment of biopolymers (directly or indirectly). Such methods may also smooth the surface of the glass. The inorganic coating (e.g., a coating of SiO₂) decreases the roughness of the glass surface and provides compositional uniformity over the glass surface. The performance of glass arrays is greatly increased by coating the array substrate in an inorganic coating according to the above methods. In general, the subject arrays are more sensitive, have less background and are less prone to artifacts than many prior art arrays. The thickness of the inorganic coating may range from about 10 Å about 200 Å, depending upon the surface roughness of the surface and desired performance of the micro-array.

In one embodiment in accordance with the invention of particular interest, a surface is coated in a silicon dioxide layer, and the silicon dioxide layer is linked to capture agents. In accordance with the invention a subject device containing a surface having a silicon dioxide coating and capture agents linked to the coating is provided.

Kits

In accordance with the invention, kits are provided for practicing the subject methods, as described above. The subject kits at least include a surface of a subject device, coated in an inorganic layer by vapor deposition. In certain embodiments, the surface may be dielectric surface of an optical device. In other embodiments, the surface may be a sample-contact surface of a micro-fluidic device or analyte-detection device. The coated surface may be linked to one or more capture agents, or may contain capture agent-reactive hydroxyl groups or groups that may be linked to hydrophobic moieties to provide a hydrophobic surface. Also included in a subject kit may be a buffer (e.g., a reaction buffer or binding buffer), labeling reagents and/or control samples that may be employed to assess a sample using a subject device. The various components of the kit may be present in separate containers or certain compatible components may be precombined into a single container, as desired.

In addition to above-mentioned components, the subject kits may further include instructions for using the components of the kit to practice the subject methods. The instructions for practicing the subject methods are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging) etc. In other embodiments, the instructions are present as an electronic storage data file present on a suitable computer readable storage medium, e.g. CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

In addition to the subject database, programming and instructions, the kits may also include one or more control analyte mixtures, e.g., two or more control analytes for use in testing the kit.

Utility

The subject methods and compositions find use in a variety of applications. In certain embodiments in accordance with the invention, the methods are optical methods in which an optical component, as described above, is employed to manipulate electromagnetic radiation. In other embodiments, the applications are analyte assessment, e.g., analyte detection, applications in which analytes in a sample are investigated, e.g., the presence of a particular analyte in a given sample is detected at least qualitatively, if not quantitatively. Each of these representative utilities is now reviewed in greater detail.

For example, the subject methods and compositions find use in optical devices, e.g., any type of optical instrumentation or camera or the like that employs an optical component, e.g., a lens or a mirror, etc. The inorganic coating of an optical substrate may be further modified to add a hydrophobic coating (e.g., by adding hydrophobic silane molecules), providing an organic substrate that repels charged particulate matter, e.g., dust.

An optical substrate produced by the above methods may generally be employed to manipulate (i.e., change the direction of, reflect, filter, polarize, split a beam of, reduce the magnitude of, transmit, diffract, etc.) at least one wavelength of electromagnetic radiation, e.g. ultra-violet, infra-red or visible light. In certain embodiments, an optical component in accordance with the invention may transmit the radiation from one side of the component to the other. In such methods, radiation is contacted with the component, and manipulated thereby. In certain embodiments, the radiation enters the coated optical component whereas in other embodiments the radiation is reflected off the surface of the coated optical component. The optical components provided herein may be employed in a wide variety of devices, for example, in optical detection equipment (e.g., light detectors and cameras or the like), laboratory instrumentation (e.g., any instrumentation that employs a light source such as a laser, for example), telecommunications devices (e.g., to provide connectors, alignment structures, switches, routers, couplers and other devices in optical communication systems, e.g., fiber optics) and in optical data storage devices. Systems in which the subject optical components may be employed may be found in U.S. Pat. Nos. 6,807,336, 6,768,834, 6,751,376, 6,570,684, 6,473,211 and 6,253,001.

In other embodiments in accordance with the invention, a subject device may be employed in a variety of methods of sample analysis. In these methods, an analyte-containing sample is contacted with a sample contact surface of a subject device, and analytes in the sample are assessed using the device. Depending on the device employed, the analytes may be assessed by detecting binding of analytes to capture agents present on a surface of the device, or by moving analytes upon the device so that they are reacted with, or separated from, other analytes that are also present on the surface of the device. Such methods are generally well known in the art.

In one embodiment in accordance with the invention, the subject methods involve contacting a subject device with a sample under specific binding conditions and assessing binding of analytes in the sample to a capture agent. As mentioned above, analytes may be detected by evanescent wave detection. In certain embodiments, an evanescent wave is detected by reflecting light off a metal layer, and detecting the angle and/or intensity of the reflected light. In other embodiments, a graphical image of the sensor surface may be produced. Binding of an analyte to capture agents present on the sensor can be detected by evaluating changes in reflected light angle and/or intensity, or changes in a graphical image, for example.

In particular embodiments in accordance with the invention, a subject device may be used in surface plasmon resonance (SPR) methods. SPR may be detected using the evanescent wave which is generated when a laser beam, linearly polarized parallel to the plane of incidence, impinges onto a prism coated with a thin metal film. SPR is most easily observed as a change in the total internally reflected light just past the critical angle of the prism. This angle of minimum reflectivity (denoted as the SPR angle) shifts to higher angles as material is adsorbed onto the metal layer. The shift in the angle can be converted to a measure of the amount of adsorbed material by using Fresnel calculations and can be used to detect the presence or absence of analytes bound to the capture agents on top of the metal layer. As is well known, SPR may be performed with or without a surface grating (in addition to the prism). Accordingly a subject sensor may contain a grating, and may be employed in other SPR methods other than that those methods explicitly described in detail herein.

In using SPR to test for binding between agents and with reference to FIG. 2B, a beam of light 62 from a laser source 60 is directed through a prism 42 (and optionally through an optically matched substrate not shown) that has one external surface covered with a thin film of a metal 44, which has a vapor deposited inorganic coating 46 that is linked to capture agents 48. A liquid sample containing analytes is introduced via chamber entrance 50 into chamber 52 defined by housing 50, and analytes of interest bind to capture agents for those analytes. The evanescent wave is detected by detecting reflected light 66 using detector 64. Sample may exit the chamber by chamber exit 58. As a greater number of analytes become bound to the capture agents, their mass concentration increases, resulting in a reduction or change in the angle of total internal reflection (i.e. the SPR angle). By monitoring either the position of the SPR angle or the reflectivity at a fixed angle near the SPR angle, the presence or absence of an analyte in the sample can be detected.

In certain embodiments in accordance with the invention, the angles of incidence and reflection are “swept” together through the resonance angle, and the light intensity is monitored as function of angle. Very close to the resonance angle, the reflected light is strongly absorbed by the gold surface, and the reflected light becomes strongly reduced. In other embodiments, the source and detector angles are fixed near the resonance angle at an initial wavelength, and the wavelength is swept to step the resonance point through the fixed angle. The beam is collimated and an entire image of the substrate is captured. In exemplary embodiments, the wavelength of the tunable laser may be between from about 0.6 μm to about 0.8 μm (i.e., having a 200 nm sweep), although tunable lasers having other sweeps (e.g., 0.8 μm to 1.0 μm, 1.0 μm to 1.2 μm, 1.2 μm to 1.4 μm, 1.4 μm to 1.6 μm or 1.6 μm to 1.8 μm may also be employed. In one embodiment, a tunable laser having a sweep of 1.45 to 1.65 μm is employed.

In another embodiment in accordance with the invention, a subject device may contain an array of capture agents linked to the inorganic coated surface, where an “array,” includes any two-dimensional or substantially two-dimensional (as well as a three-dimensional) arrangement of spatially addressable regions (i.e., “features”) containing capture agents. The term “array” encompasses the term “microarray” and refers to an array of capture agents for binding to aqueous analytes and the like. References describing methods of using arrays in various applications include U.S. Pat. Nos. 5,143,854; 5,288,644; 5,324,633; 5,432,049; 5,470,710; 5,492,806; 5,503,980; 5,510,270; 5;525,464; 5,547,839; 5,580,732; 5,661,028; 5,800,992, the disclosures of which are herein incorporated by reference.

Protocols for carrying out array assays are well known to those of skill in the art and need not be described in great detail here. Generally, a sample containing an analyte of interest is contacted with an array under conditions sufficient for the analyte to bind to its respective binding pair member that is present on the array. Thus, if the analyte of interest is present in the sample, it binds to the array at the site of its complementary binding member and a complex is formed on the array surface. The presence of this binding complex on the array surface is then detected, e.g., through use of a signal production system such as a fluorescent label present on the analyte, etc., where detection includes scanning with an optical scanner. The presence or amount of the analyte in the sample is then deduced from the detection of binding complexes on the substrate surface.

Specific analyte detection applications of interest include hybridization assays. In these assays, a sample of target nucleic acids is first prepared, where preparation includes labeling of the target nucleic acids with a label. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: genomic hybridization, gene discovery assays, differential gene expression analysis assays; nucleic acid sequencing assays, mutation detection, and the like.

In using an array in connection with the methods in accordance with the invention, the array will typically be exposed to a labeled sample (such as a fluorescently labeled analyte, e.g., protein or nucleic acid containing sample) and the array then read. Binding complexes on the surface of the array are detected by determining the location and intensity of resulting fluorescence at each feature of the array. Once read, array scans are subject to image analysis and feature extraction to obtain at least two numerical data points for each feature of the array, and this data is analyzed to yield information on the amount of a particular nucleic acid in a sample of nucleic acids, if any.

Results from reading a subject device may be raw results or may be processed results such as obtained by applying saturation factors to the readings, rejecting a reading which is above or below a predetermined threshold and/or any conclusions from the results (such as whether or not a particular analytes may have been present in the sample). The results of the reading (processed or not) may be forwarded (such as by communication) to a remote location if desired, and received there for further use (such as further processing). Stated otherwise, in certain variations, the subject methods may include a step of transmitting data from at least one of the detecting and deriving steps, to a remote location. The data may be transmitted to the remote location for further evaluation and/or use. Any convenient telecommunications means may be employed for transmitting the data, e.g., facsimile, modem, Internet, etc. Alternatively, or in addition, the data representing results may be stored on a computer-readable medium of any variety such as noted above or otherwise. Retaining such information may be useful for any of a variety of reasons as will be appreciated by those with skill in the art.

### EXAMPLES

The following examples are put forth so as to provide those skilled in the art with a complete disclosure and description of how to make and use embodiments in accordance with the invention, and are not intended to limit the scope of what the inventors regard as their invention. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1

Degassed water is placed in catalyst storage container and heated to a temperature of about 30° C. to produce a vapor which was passes through a transfer line to accumulate in a first vapor reservoir. The vapor reservoir has a volume of 300 cc, and is held at a pressure of 16 Torr. A tetrachlorosilicate precursor is placed in a storage container and heated to a temperature of 30° C. to produce a vapor which is passed through the transfer line to accumulate in a second vapor reservoir. The second vapor reservoir has a volume of 50 cc and is held at a pressure of 50 Torr.

A dielectric optical component or a part containing a sample contact area of a device adapted to be contacted with an analyte-containing sample is manually loaded onto a substrate holder in the reaction chamber. The reaction chamber, having a volume of about 2 liters, is pumped down to about 20 mTorr and purged with nitrogen gas prior to and after the coating reaction. The reaction chamber is then vented to atmosphere. The process chamber is then purged using nitrogen (filled with nitrogen to 10 Torr/pumped to 0.7 Torr, five times). The surface was treated with a remotely generated oxygen plasma from a plasma source. Oxygen is directed into a plasma generation source through a mass flow controller. The oxygen flow rate for plasma generation, based on the desired plasma residence time for process chamber is about 200 sccm. The surface is treated with the oxygen plasma at a pressure of about 0.6 Torr for a time period of about 5 minutes. The plasma treatment is discontinued, and the reaction chamber is pumped down to the base pressure of about 30 mTorr.

The water vapor reservoir is charged with water vapor to a pressure of 16 Torr. The valve between the water vapor reservoir and reaction chamber is opened until both pressures equalized (a time period of about 5 seconds) to about 0.8 Torr. The water vapor reservoir is charged with vapor to 16 Torr a second time, and this volume of vapor is dumped into the reaction chamber, bringing the total water vapor pressure in the reaction chamber to about 1.6 Torr. The precursor vapor reservoir is charged with the precursor vapor to 50 Torr, and the precursor vapor is added immediately after completion of the water vapor addition. The valve between the precursor vapor reservoir and reaction chamber is opened until both pressures were equalized (a time period of about 5 seconds) to about 4 Torr. The process will be optimized for the desired film thickness by adjusting the relative mole percent of the precursors. The water and precursor vapors are maintained in the reaction chamber for a specific time period ranging from 1-20 minutes depending on the desired thickness. The reaction chamber is then pumped back to the base pressure of about 30 mTorr.

The reaction chamber is then purged (filled with nitrogen to 10 Torr/pumped to 0.7 Torr) five times. The process chamber is then vented to atmosphere, and the surface is manually removed from the reaction chamber.

The above discussion demonstrates a new vapor deposition coating method for coating optical components and sample contact surfaces of devices adapted to be contacted with an analyte-containing sample. The method is readily adaptable to a variety of surfaces, and can be tailored to produce an inorganic surface of desired properties. Prior art devices can be modified to contain these coatings, and their performance will be improved greatly form this modification. Accordingly, the subject system represents a significant contribution to the art.

All publications and patents cited in this specification are herein incorporated by reference as if each individual publication or patent were specifically and individually indicated to be incorporated by reference.

While the invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the invention. All such modifications are intended to be within the scope of the claims appended hereto.

What is claimed is:

1. A method comprising:
contacting a surface with a vaporized inorganic compound under conditions suitable for production of an inorganic coating on said surface, wherein said surface is chosen from:
a dielectric surface of an optical component; and
a sample-contact surface of a device adapted to be contacted with an analyte-containing sample.

2. The method of claim 1, wherein said inorganic compound is a silicon, titanium or aluminum-containing compound.

3. The method of claim 1, wherein said inorganic compound is a silicon-containing compound.

4. The method of claim 1, wherein said contacting is done in a reaction chamber.

5. The method of claim 1, wherein said contacting is done at about 20° C. to about 200° C.

6. The method of claim 1, wherein said contacting is done in the presence of H₂O, oxygen, nitrogen or ammonia.

7. The method of claim 1, wherein said contacting is done under controlled pressure.

8. The method of claim 1, wherein said vaporized inorganic compound compound is a tetrahalosilane or a trihalosilane compound.

9. The method of claim 8, wherein said vaporized silicon-containing compound is tetrachlorosilane (SiCl₄), tetrafluorosilane (SiF₄), tetrabromosilane (SiBr₄), trichlorosilane (HSiCl₃), trifluorosilane (HSiF₃) or tribromosilane (HSiBr₃).

10. The method of claim 1, wherein said optical component is made of a polymer and said vaporized inorganic material is contacted directly with said polymer in said method.

11. The method of claim 1, wherein said optical component is a lens, mirror, filter, polarizer, beam splitter, connector or prism.

12. The method of claim 1, wherein said device adapted to be contacted with an analyte-containing sample is an analyte detection device.

13. The method of claim 12, further comprising linking a capture agent to said inorganic layer.

14. The method of claim 1, wherein said device adapted to be contacted with an analyte-containing sample is a microfluidic device.

15. A device comprising:
a surface having a vapor deposited inorganic coating, wherein said surface is chosen from:
a dielectric surface of an optical component; and
a sample-contact surface of a device adapted to be contacted with an analyte-containing sample

16. The device of claim 15, wherein said optical component is a lens, mirror, filter, polarizer, beam splitter, connector or prism.

17. The device of claim 15, wherein said optical component is made of a dielectric polymer.

18. The device of claim 15, wherein said optical component further comprises a hydrophobic layer on said inorganic coating.

19. The device of claim 15, wherein said device is an analyte detection device.

20. The device of claim 19, wherein said analyte detection device further comprises a capture agent linked to said inorganic coating.

21. The device of claim 20, wherein said device is adapted for detecting an analyte that binds to said capture agent.

22. The device of claim 15, wherein said device adapted to be contacted with an analyte-containing sample is a microfluidics device.

23. The device of claim 21, wherein said device is made from polydimethylsiloxane (PDMS), polyimide or an organic polymer.

24. The device of claim 15, wherein said vapor deposited inorganic coating comprises metal oxide or metal nitride.

25. The device of claim 15, wherein said vapor deposited inorganic coating is a silicon dioxide coating.

26. The device of claim 15, wherein said inorganic layer is from about 5 Å to about 1000 Å in thickness.

27. The device of claim 15, wherein said device adapted-to be contacted with an analyte containing sample is a surface plasmon resonance detector comprising:
a prism;
a layer of a metal upon a surface of said prism; and
a vapor deposited inorganic coating upon said layer of metal.

28. The device of claim 15, wherein said device is chosen from a perforated metal sensor and a dielectric photonic crystal sensor.

29. The device of claim 19, wherein said device is a nanostructure sensor comprising:
a nanostructure; and
a vapor deposited inorganic coating upon a surface of said nanostructure.

30. The device of claim 29, wherein said nanostructure comprises carbon nanotubes, silicon nanowires, nanoparticles or nanopores.

31. The device of claim 19, wherein said device is a nanowire, nanotube or nanopore sensor.

32. A method of sample analysis, comprising:
contacting an analyte-containing sample with a device comprising a surface having a vapor deposited inorganic coating; and
assessing analytes in said sample using said device.

33. The method of claim 32, wherein said device further contains a capture agent linked to said vapor deposited inorganic layer.

34. The method of claim 33, wherein said assessing includes detecting any analytes bound to said capture agent.

35. The method of claim 32, wherein said device is a microfluidic device and said method comprises transporting analytes in said sample from a first position to a second position on said device.
